(19) United States
(12) Patent Application Publication
(10) Pub. No.: US 2018/0285563 A1
(43) Pub. Date: Oct. 4, 2018

(54) TECHNIQUES FOR SERVICE ASSURANCE USING FINGERPRINTS ASSOCIATED WITH EXECUTING VIRTUALIZED APPLICATIONS

(71) Applicant: Intel Corporation, Santa Clara, CA (US)

(72) Inventors: John BROWNE, Limerick (IE); Vadim SUKHOMLINOV, Santa Clara, CA (US); Timothy VERRALL, Pleasant Hill, CA (US); Eoin WALSH, Shannon (IE)

(21) Appl. No.: 15/476,827

(22) Filed: Mar. 31, 2017

(51) Int. Cl. G06F 21/55; G06F 21/45; G06F 21/12; G06F 21/53; G06F 21/32; G06F 21/54; G06F 21/56

(52) U.S. Cl. CPC G06F 21/554; G06F 21/45; G06F 21/126; G06F 21/53; G06F 21/566; G06F 21/54; G06F 21/563; G06F 21/565; G06F 21/32

(57) ABSTRACT

Examples include techniques for a service assurance using fingerprints associated with execution of virtualized applications. Examples include receiving information for computing events gathered while a virtual machine executes one or more applications to process a workload for a virtual network function over a period of time. A service performance risk may be reported based on a sample fingerprint generated using the gathered computing events.

### TECHNICAL FIELD

Examples described herein are generally related monitoring behaviors associated with one or more applications executed by a virtual machine.

### BACKGROUND

A relatively new technology referred to as network function virtualization (NFV) is rapidly evolving over recent years. In some examples, NFV infrastructure is becoming increasingly important to large data centers or telecommunication providers to allow for a pooling of at least some computing resources that may be disaggregated and/or located in diverse geographic locations. In an example virtualized environment for NFV infrastructure, multiple virtual machines (VMs) may be hosted by a host computing system. The multiple VMs may separately execute one or more virtual network functions (VNFs) or applications associated with the one or more VNFs. A given VNF executed by one or more VMs may fulfill a function that may have been previously implemented using dedicated hardware devices (e.g., firewalling, network address translation, etc.). Also, virtualized network environments are also able to provide a variety of new applications and/or services to the end users. For example, deployments where single computing applications are packaged into special purpose virtual computing nodes (e.g., containers and VMs) are gaining widespread acceptance with the maturing of Docker® and other similar virtualization technologies.

### BRIEF DESCRIPTION OF THE DRAWINGS

FIG. 1 illustrates an example system.

FIG. 2 illustrate an example input/output scheme for a monitoring daemon.

FIG. 3 illustrates an example block diagram for a monitoring daemon.

FIG. 4 illustrates an example process.

FIG. 5 illustrates an example block diagram for an apparatus.

FIG. 6 illustrates an example of a logic flow.

FIG. 7 illustrates an example of a storage medium.

FIG. 8 illustrates an example block diagram for a computing platform.

### DETAILED DESCRIPTION

In an example virtualized environment for NFV infrastructure, multiple VMs may be hosted by a computing system. The multiple VMs may separately execute one or more VNFs. In some examples, a hypervisor or virtual machine manager (VMM) implemented by an operating system (OS) of a host computing platform may allocate compute resources including, but not limited to, central processing units (CPUs), CPU cores, memory, storage or networking resources to VMs. Applications executed by VMs in NFV type infrastructures of today may fail, hypervisors/VMMs arranged to manage VMs may fail and/or CPUs/cores allocated to VMs may fail. Currently, human intervention may be required to address failures by inferring causes of failure via outside analysis of an application's behavior either at a networking or telemetry level.

Telecommunications usage models may have an NFV type infrastructure and have requirements for 99.999% (five 9s) uptime. A 99.999% uptime requirement allows for VMs to be down or non operational for no more than 5.26 minutes in an entire year. Human intervention to address failures may not be feasible for only a few minutes per year of downtime. Therefore, an automated solution may be required to meet 99.999% uptime requirements. Current software schemes for automated solutions may not be able to detect all cases of failure and may also involve direct instrumentation of software with service assurance middleware to detect software faults and additional allocation of compute resources to detect hardware faults. Further complexity in attempts at an automated solution may be added for VNFs executed by VMs supported by physical compute resources (e.g., CPUs/cores) in that these VNFs may have no visibility into faults in these supporting physical compute resources. It is with respect to these challenges that the examples described herein are needed.

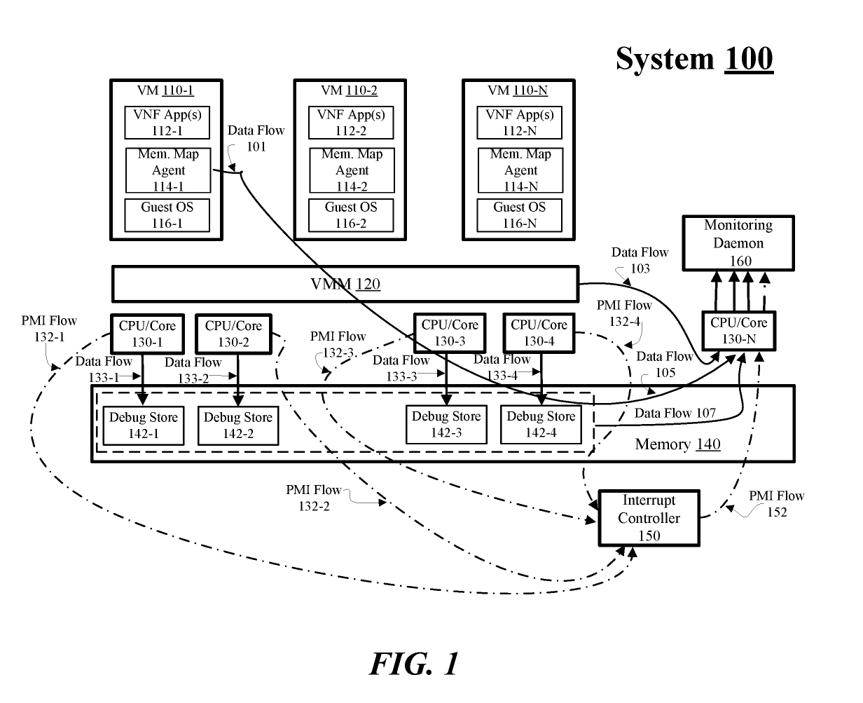

FIG. 1 illustrates an example system 100. In some examples, system 100 includes a plurality of virtual machines (VMs) such as VMs 110-1 to 110-N, where “N” as used for VMs 110-1 to 110-N and other elements of system 100 hereinafter refers to any positive integer greater than 2. VMs 110-1 to 110-N may be managed or controlled by a VM manager (VMM) or hypervisor such as VMM 120. VMs 110-1 to 110-N may be supported by computing resources such as, but not limited to, CPUs/cores 130-1, 130-2, 130-3 or 130-4 and memory 140.

In some examples, computing resources including CPUs/cores 130-1 to 130-4 and memory 140 may be physical elements arranged as part of an NFV infrastructure that supports virtual elements such as VMs 110-1 to 110-N that may separately execute one or more virtual network function (VNF) applications. For example, VMs 110-1, 110-2 and VM 110-N may respectively execute VNF app(s) 112-1, 112-2 and 112-N. According to some examples, VNF app(s) 112-1, 112-2 or 112-N may fulfill a function, task or service that may include, but is not limited to, a firewalling service, a domain name service (DNS), a caching service or network address translation (NAT) service.

According to some examples, VMs 110-1 to 110-N may respectively include guest operating systems (OSs) 116-1 to 116-N that facilitate execution of respective VNF app(s) 112-1 to 112-N by VMs 110-1 to 110-N. Guest OSs 116-1 to 116-N may be represented as an OS kernel plus system libraries and services in examples of hardware virtualization or may be just system libraries and services in examples of application stack virtualization where guest OS kernels may be shared (e.g., by containers). Also, VMs 110-1 to 110-N may include respective memory map agents 114-1 to 114-N to perform memory mapping that connects host physical addresses (HPAs) for portions of memory 140 allocated to a given VM to virtual or linear guest memory addresses (GPAs) used by one or more VNF applications executed by the given VM. For example, memory map agent 114-1 of VM 110-1 may map HPAs at memory 140 allocated to VM 110-1 for execution of VNF app(s) 112-1 to GPAs used by VNF app(s) 122-1 when processing or handling workloads. As described more below, memory mapping may facilitate sample fingerprints associated with behaviors of one or more VNF applications being executed by a VM while those one or more VNF applications process a workload.

In some examples, a monitoring daemon 160 may be executed by a CPU/core of system 100 that is separate from CPUs/cores 130-1 to 130-4 included in compute resources provisioned or allocated to VMs 110-1 to 110-N. Although, in some examples, monitoring daemon 160 may be executed by the same CPUs/cores allocated to VMs 110-1 to 110-N. Also, monitoring daemon 160 may be on same or different computing platform as other elements of system 100 and as such, CPU/core 130-N may also be respectively located on the same or different computing platform. As shown in FIG. 1, the separate CPU/core to execute monitoring daemon 160 is shown as CPU/core 130-N. As described in more detail below, monitoring daemon 160 may include logic and/or features to receive data and/or performance monitoring interrupts (PMIs) to determine sample fingerprints for target workloads processed by VNF app(s) 110-1 to 110-N executed by VMs 110-1 to 110-N. Logic and/or features of monitoring daemon 116 may then compare the sample fingerprints with respective fingerprint references associated with respective behavior models to determine a deviation from normal and/or expected behavior.

According to some examples, as shown in FIG. 1, CPUs/cores 130-1 to 130-4 may each have a portion of memory 140 for maintaining respective debug stores 142-1 to 142-4. For these examples, CPUs/cores may be programmed to store microarchitecture or computing events in dedicated portions of memory 140 that are arranged to maintain debug stores 142-1 to 142-4. The computing events may be associated with behaviors exhibited by CPUs/cores 130-1 to 130-4 while supporting VMs 110-1 to 110-N while these VMs execute respective VNF app(s) 112-1 to 112-N while these VNF app(s) process respective workloads. Computing events may be marked or tracked via various event trace techniques including, but are not limited to, precise event based sampling (PEBS), processor trace (PT), branch target store (BTS) or embedded trace microcell (ETM). PEBS, PT or BTS event trace techniques may be associated with Intel® based microprocessor architectures and ETM may be associated with ARM® based microprocessor architectures. However, examples are not limited to only these types of microprocessor architectures and associated event trace techniques. The above-mentioned example event trace techniques may track or monitor microarchitecture or computing events exhibited by CPU/cores such as, but not limited to, instructions retired, branch miss predicts, cache misses, translation lookaside buffer (TLB) misses or other types of microarchitecture or computing events.

According to some examples, debug stores 142-1 to 142-4 may store microarchitecture or computing events in a CPU-specific format via respective data flows 133-1 to 133-4 from respective CPUs/cores 130-1 to 130-4. The CPU-specific format may include a microarchitecture or computer event identifier (ID) and an address where the specific microarchitecture or computer event took place (typically an HPA of executed instruction or operated data). The CPU-specific format may be depicted as [event ID, address] tuples, where “event ID” represents a type of computing or microarchitecture event and “address” represents the HPA associated with the computing or microarchitecture event. For example, a tuple of [L1-miss, OxFA803911] stored to debug store 142-1 by CPU/core 130-1 may identify a cache level 1 (L1) miss at an HPA location of OxFA803911 in a memory utilized by CPU/core 130-1 as an L1 cache (not shown).

In some examples, CPUs/cores 130-1 to 130-4 may issue PMIs and route those PMIs to an interrupt controller 150. For these examples, PMIs may be routed to interrupt controller 150 via PMI flows 132-1 to 132-4 as shown in FIG. 1. A PMI may be routed from CPUs/cores 130-1 to 130-4 to interrupt controller 150 based on capacity thresholds being exceeded for storing data associated with computing or microarchitecture events stored to respective debug stores 142-1 to 142-4. In some examples, interrupt controller 150 may then forward received PMIs to CPU 130-N that is executing monitoring daemon 160 via PMI flow 152. Although interrupt controller 150 is shown as a separate element of system 100, in some examples, interrupt controller 150 may part of internal logic for CPUs/cores 130-1 to 130-4 (e.g., located on a same die or chip) and may serve as an application programmable interrupt controller (APIC) programmed to redirect PMIs from CPUs/cores 130-1 to 130-4 to CPU/core 130-N executing monitoring daemon 160. The depiction of interrupt controller 150 as a separate element is shown in FIG. 1 to simplify this process of redirecting PMIs generated by CPUs/cores 130-1 to 130-4 to CPU/core 130-N.

According to some examples, debug stores 142-1 to 142-4 may be configured to maintain PEBS buffers. For these examples, trace event data (e.g., cache misses) gathered or collected via PEBS techniques by CPUs/cores 130-1 to 130-4 may be stored to debug stores 141-1 to 142-4 via respective data flows 133-1 to 133-4. A PEBS interrupt threshold may be set for each PEBS buffer maintained in debug stores 142-1 to 142-4 to trigger a PMI if the PEBS interrupt threshold is met or exceeded. The PMI may be routed from the CPU/core having the PEBS buffer in its debug store that met or exceeded the PEBS interrupt threshold to interrupt controller 150 and then the PMI may be forwarded to CPU/core 130-N. This routing of the PMI to interrupt controller 150 for forwarding to CPU/core 130-N that executes monitoring daemon 160 enables other CPU/cores of system 100 to perform monitoring duties and unburdens CPU/cores provisioned to support VMs executing VNF applications.

In some examples, the PEBS interrupt threshold may be a field maintained in a PEBS index (not shown) to specify a threshold value to trigger the PMI and notify monitoring daemon 160 that the PEBs buffer is nearly full. This field may be programmed (e.g. by monitoring daemon 160) with a linear address of a first byte of a PEBS record stored in the PEBS buffer that represents a threshold record. For these examples, a given CPU/core may cause a PEBS record to be written to the PEBS buffer and then a PEBS index may be updated. If the PEBS index reaches the threshold value of this field, the given CPU/core will generate a PMI and route this PMI to interrupt controller 150. Interrupt controller 150 will then forward the PMI to CPU/core 130-N executing monitoring daemon 160 to indicate that the given CPU/core's PEBS buffer is nearly full.

According to some examples, monitoring daemon 160 may subscribe to notifications from VMM 120. These notifications may be routed via data flow 103 and may include VM/CPU context data. For these examples, VM/CPU context data may indicate what CPU/core has been assigned or allocated to support a given VM. The VM/CPU context data may be included in tuples that include [timestamp, VM ID, CPU/core ID], meaning that at a specific moment in time a VM having an identifier “VM ID” was supported by a CPU/core having an identifier “CPU/core ID” for executing one or more VNF applications. Other types of VM/CPU context data may include, but are not limited to, what active processes are being executed by the given VM. For example, what types of workloads are being processed by the one or more VNF applications.

In some examples, responsive to receiving PMIs from CPUs/cores 130-1 to 130-4, monitoring daemon 160 may read or request event trace data from debug stores 142-1, 142-2, 142-3 or 142-4 via data flow 107. For example, monitoring daemon 160 may read or request information from PEBS buffers maintained in debug stores 142-1, 142-2, 142-3 or 142-4 responsive to a PMI that is forwarded from interrupt controller 150 as mentioned above based on these PEBS buffers being nearly full.

According to some examples, memory map data or notifications may be routed to monitoring daemon 160 from memory map agents 114-1, 114-2 or 114-N to provide information on how HPAs of memory 140 allocated to respective VMs 110-1 to 110-N map to virtual or linear GPAs used by respective VNF app(s) 112-1 to 112-N to process workloads. For example, memory map data from memory map agent 114-1 at VM 110-1 may be routed via data flow 101 to monitoring daemon 160 as shown in FIG. 1 to indicate GPA to HPA mapping for VNF app(s) 112-1 to process workloads.

In some examples, CPUs/cores 130-1 to 130-N and memory 140 may be hosted by one or more host computing platforms that may include, but are not limited to, a server, a server array or server farm, a web server, a network server, an Internet server, a work station, a mini-computer, a main frame computer, a supercomputer, a network appliance, a web appliance, a distributed computing system, multiprocessor systems, processor-based systems, or combination thereof.

In some examples, CPUs/cores 130-1 to 130N may represent, either individually or collectively, various commercially available processors, including without limitation an AMD® Athlon®, Duron® and Opteron® processors; ARM® application, embedded and secure processors; IBM® and Motorola® DragonBall® and PowerPC® processors; IBM and Sony® Cell processors; Intel® Atom®, Celeron®, Core (2) Duo®, Core i3, Core i5, Core i7, Itanium®, Pentium®, Xeon® or Xeon Phi® processors; and similar processors.

According to some examples, memory 140 may be composed of one or more memory devices or dies which may include various types of volatile and/or non-volatile memory. The one or more memory devises or dies may include various types of volatile and/or non-volatile memory. Volatile memory may include, but is not limited to, random-access memory (RAM), Dynamic RAM (D-RAM), double data rate synchronous dynamic RAM (DDR SDRAM), static random-access memory (SRAM), thyristor RAM (T-RAM) or zero-capacitor RAM (Z-RAM). Non-volatile memory may include, but is not limited to, non-volatile types of memory such as 3-dimensional (3-D) cross-point memory that may be byte or block addressable. Byte or block addressable non-volatile types of memory may also include, but are not limited to, memory that uses chalcogenide phase change material (e.g., chalcogenide glass), multi-threshold level NAND flash memory, NOR flash memory, single or multi-level phase change memory (PCM), resistive memory, nanowire memory, ferroelectric transistor random access memory (FeTRAM), magnetoresistive random access memory (MRAM) that incorporates memristor technology, spin transfer torque MRAM (STT-MRAM), or a combination of any of the above, or other non-volatile memory types.

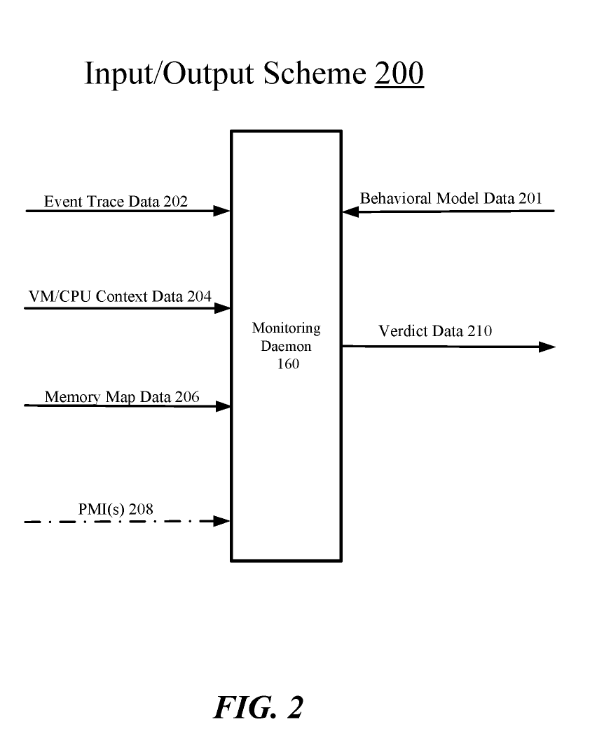

FIG. 2 illustrates an example input/out scheme 200. In some examples, as shown in FIG. 2, scheme 200 includes input/outputs to monitoring daemon 160. For these examples, behavior model data 201, event trace data 202, VM/CPU context data 204, memory map data 206 and PMI(s) 208 may include various types of inputs received by monitoring daemon 160. Meanwhile, verdict data 210, as described more below, may be a type of output generated by monitoring daemon 160. At least some of the various types of inputs to monitoring daemon 160 such as event trace data 202, VM/CPU context data 204, memory map data 206 or PMI(s) 208 may be routed through the CPU/core executing monitoring daemon 160. For example, as mentioned previously for FIG. 1, various data or PMI flows may be routed through CPU/core 130-N to reach monitoring daemon 160.

According to some examples, the input of behavior model data 201 may be received from a management entity of system 100 (not shown) or may be loaded at time of initiation of monitoring daemon 160. For these examples, behavior model data 201 inputted to monitoring daemon 160 may include one or more reference fingerprints that are based on targeted workloads (e.g., NAT or DNS workloads) to be processed by VNF applications executed at VMs 110-1 to 110-N. The reference fingerprint included in behavior model data 201 may reflect expected behavior of VNF applications. For example, expected numbers and types of microarchitecture or computing events (e.g., instructions retired, branch miss predicts, cache misses, TLB misses, etc.) generated by the VNF applications executed by a given VM while processing the targeted workload over a period of time may be reference fingerprints included in the behavior model data 201.

In some examples, monitoring daemon 160 may include logic and/or features to gather information from event trace data 202, VM/CPU context data 204, memory map data 206 and PMI(s) 208 and may process this data to generate a sample fingerprint associated with one or more VNF applications executed by a given VM processing actual, runtime workloads over a given time period (e.g., several minutes or hours). As described more below, the logic and/or features of monitoring daemon 160 may compare the reference fingerprint of the targeted workload being processed by the VNF applications to the sample fingerprint to determine a deviation from normal and/or expected operations. Verdict data 210 may include an indication to a management entity of whether or not that comparison indicates the VNF applications and associated VMs, CPUs/cores or memory are operating as expected. According to some examples, if the deviation from normal and/or expected operations is above a threshold, verdict data 210 may include an indication to a management entity that possible problems need to be addressed by the management entity. In other examples, monitoring daemon 160 may include logic and/or features to further analyze a determined deviation from normal and/or expected operations if the deviation is relatively small or within an acceptable range of deviation. For these other examples, a relatively small deviation may be acceptable (e.g., associated with normal/expected deviations) and verdict data 210 may indicate no problems need to be addressed by the management entity. Also, for these other examples, monitoring daemon 160 may include logic and/or features to adjust the reference fingerprints based on the sample fingerprints to update the behavior model for future comparisons of the updated reference fingerprints with subsequent sample fingerprints. Alternatively, monitoring daemon 160 may cause an adjustment to the reference fingerprints by logic and/or features remote to monitoring daemon 160 that may have more compute power to update the behavior model for future comparisons.

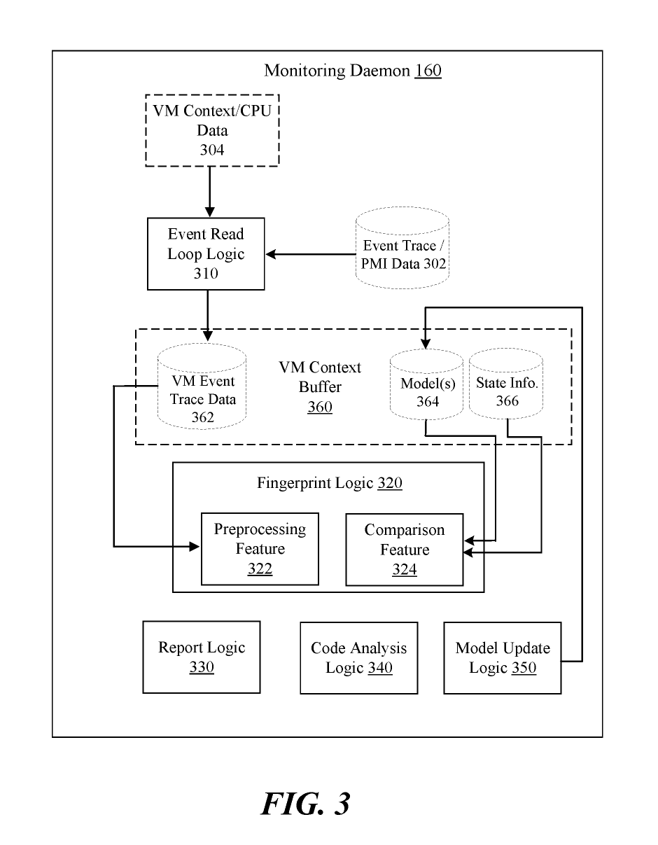

FIG. 3 illustrates an example block diagram for monitoring daemon 160. In some examples, monitoring daemon 160 as shown in FIG. 3, includes an event read loop logic 310, a fingerprint logic 320, a report logic 330, a code analysis logic 340 or a model update logic 350. For these examples, the elements of FIG. 3 having dashed lines may represent data received or gathered by logic and/or features of monitoring daemon 160 and/or structures to maintain data received or gathered by logic and/or features of monitoring daemon 160 (e.g., stored to memory 140 or maintained/stored remote to a computing platform hosting monitoring daemon 160). For example, a VM context buffer 360 may maintain data received or gathered by event read loop logic 310 such as data gathered or received from event trace/PMI data 302 or from VM context/CPU data. VM context buffer 360 may also maintain model(s) 364 and state information 366.

According to some examples, microarchitecture or computing events from event trace/PMI data 302 and VM context CPU data 304 for a given VM executing one or more VNF applications while processing a workload may be gathered or read by event read loop logic 310 and combined. The combined data may be added to VM event trace data 362 of VM context buffer 360. For these examples, VM context buffer 360 may be allocated to or specific to the given VM. Model(s) 364 may include one or more behavior models for the given VM having fingerprint references based on respective one or more targeted workloads. Also, an internal processing state of the given VM is maintained with state information 366. Model(s) 364 may be stored locally at a same computing platform hosting monitoring daemon 160 or may be retrieved from a different computing platform located remoted to monitoring daemon 160's hosting computing platform.

In some examples, as shown in FIG. 3, fingerprint logic 320 may include a preprocessing feature 322 and a comparison feature 324. For these examples, preprocessing feature 322 may be capable of processing information obtained from VM event trace data 362 to generate a sample fingerprint. Comparison feature 324 may capable of comparing the sample fingerprint to reference fingerprint obtained from the model(s) 364 considering the internal processing state of the given VM obtained from state information 366 and/or indicated in VM event trace data 362.

According to some examples, comparison features 324 may generate a deviation value based on the comparison of the sample fingerprint to the reference fingerprint. The deviation value may indicate an amount of deviation of the sample fingerprint from the reference fingerprint. For example, a deviation value for how many cache misses or TLB misses were observed in the sample fingerprint versus a number of cache misses or TLB misses in the reference fingerprint may be generated by comparison feature 324. The deviation value may be normalized for measurements of a distance between the reference fingerprint and the sample fingerprint. For example, the reference fingerprint may represent a frequency of different types of computing instruction executions for each range of code addresses. When normalizing the deviation value, code analysis logic 340 may use an example fifty code ranges with the most computing instructions and then measure the distance in a 50-dimensional space between the sample fingerprint and the reference fingerprint.

In some examples, comparison feature 324 may use other methods to compare the sample fingerprint to the reference fingerprint. These other methods may include, but are not limited to, use of artificial intelligence/machine learning methods such fuzzy logic, artificial neural networks or other types of similar artificial intelligence/machine learning methods. These other methods may enable more complex comparison scheme than a straight comparison of a deviation value and may allow for complex feature abstractions and pattern detection.

According to some examples, when using a deviation value methodology, if a deviation value generated by comparison feature 324 is above a threshold, report logic 330 may indicate to a management entity that possible problems need to be addressed by the management entity. This type of indication may just be an alert that possible issues exist and need to be further investigated.

In some examples, if a deviation value generated by comparison feature 324 is above a threshold, code analysis logic 340 may perform additional analysis before determining whether to have report logic 330 send an alert or a report. For these examples, further analysis on whether the deviation value above the threshold is not normal (e.g., caused from a security threat and/or service performance risk) or is normal (e.g., within expected deviations for a given internal processing state of the VM). The threshold deviation criteria or value may be equal and/or exceed the deviation value when the reference fingerprint does not include computing behavior seen during behavior model creation. Alternatively, the threshold deviation criteria or value may equal and/or exceed the deviation score when the one or more VNF applications executed by the given VM being monitored accesses some critical system function that is symptomatic of a security attack. Service performance risk may be a risk that one or more of the VNF applications are malfunctioning or exhibiting signs that a malfunction is imminent such that services associated with a VNF are at risk of reaching unacceptable performance levels.

According to some examples, a malfunction may be due to one or more CPU/cores beginning to fail or physical memory failure. Code analysis logic 340 may use a variety of data analysis techniques that may include, but are not limited to, binary translation, emulation, various heuristics, signature matching to determine whether a deviation is caused from a service performance risk and to determine whether the deviation is normal or expected for a given internal processing state of the VM executing one or more VNF applications that may or may not be malfunctioning. Report logic 330 may report the results of an analysis indicating a service performance risk to a management entity for further action. In other words, if the analysis indicates the sample fingerprints indicate operations that are not normal for the VM executing the one or more VNF applications while processing the workload, a report of the service performance risk may be sent by report logic 330 to the management entity.

In some examples, if code analysis logic 340 determines that a sample fingerprint indicates operations are normal for the given VM executing the one or more VNF applications, then model update logic 350 may update at least one behavior model for the given VM and store that updated behavior model in model(s) 364. For these examples, the updated behavior model may be based on information in VM event trace data 362 that was read or gathered by event read loop logic 310 then used by preprocessing feature 322 of fingerprint logic 320 to generate the sample fingerprint. In other words, the sample fingerprint becomes a reference fingerprint in the updated behavior model for comparison to subsequently generated sample fingerprints. Although model update logic 350 is shown in FIG. 3 as being part of monitoring daemon 160, in alternative examples, model update logic 350 may be located separate from or remote to the computing platform hosting and/or CPU/core supporting monitoring daemon 160. For these alternative examples, updating behavior models may be prohibitively compute intensive for a monitoring daemon and thus dedicated CPUs/cores and/or a dedicated remote computing platform may be needed by model update logic 350 in order to update behavior models.

According to some examples, a behavior model for the given VM executing the one or more VNF applications processing the workload may not be included in model(s) 364. For these examples, monitoring daemon 160 may be in a learning phase. For this learning phase, preprocessing feature 322 may generate the sample fingerprint and comparison feature 324 may indicate to model update logic 350 to generate a new behavior model using the sample fingerprint and adding the sample fingerprint to model(s) 364. Subsequent sample fingerprints may then be compared by comparison feature 324 based on this new behavior model.

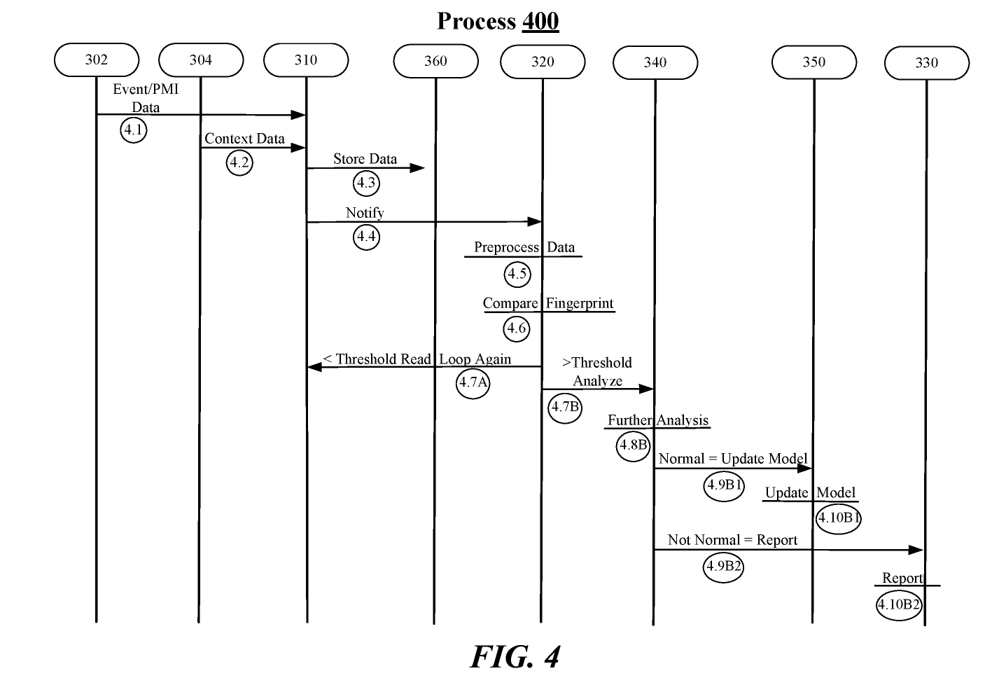

FIG. 4 illustrates an example process 400. In some examples, process 400 may be for a logic and/or features of a monitoring daemon to gather information for sample fingerprints associated with behavior of one or more VNF applications being executed by a VM while those one or more VNF applications process a workload over a period of time. For these examples, elements of monitoring daemon 160 as shown in FIG. 3 may be related to process 400. These elements of monitoring daemon 160 may include, but are not limited to, event trace/PMI data 302, VM context/CPU data 304, event read loop logic 310, VM context buffer 360, fingerprint logic 320, code analysis logic 340, model update logic 350 or report logic 330. Further, elements of system 100 shown in FIG. 1 and example scheme 200 as shown in FIG. 2 may also be related to process 400. However, example process 400 is not limited to implementations using elements of monitoring daemon 160 shown in FIG. 3, elements of system 100 shown in FIG. 1, or example schemes 200 shown in FIG. 2.

Beginning at process 4.1, event/PMI data may be gathered or read by event read loop logic 310 for a VM such as VM 110-1 shown in FIG. 1. In some examples, the event/PMI data may be gathered or read from event trace/PMI data 302. Event trace/PMI data 302 may include microarchitecture or computing events received via event trace data 202 and/or PMI(s) 208 as VM 110-1 executes VNF app(s) 112-1 as one or more of these VNF applications process a workload over a period of time.

Moving to process 4.2, context data may be gathered or read by event read loop logic 310 for VM 110-1. In some examples, the context data may be gathered from VM context/CPU data 304. VM context/CPU data may include what CPU/core from among CPUs/cores 130-1 to 130-4 has been assigned or allocated to support VM 110-1 and other associated information (e.g., timestamps and identifiers). The VM context/CPU data may be receive via VM/CPU context data 204 as shown in FIG. 2.

Moving to process 4.3, event read loop logic 310 may cause the gathered or read event/PMI data and the context data to be stored to VM context buffer 360. According to some examples, VM context buffer 360 may be specific to VM 110-1 and the event/PMI and context data may be stored to VM event trace data 362 as indicated in FIG. 3.

Moving to process 4.4, event read loop logic 310 may notify fingerprint logic 320 that data has been stored to VM context buffer 360.

Moving to process 4.5, preprocessing feature 322 of fingerprint logic 320 may gather data from VM event trace data 362 to preprocess the data to generate a sample fingerprint.

Moving to process 4.6, comparison feature 324 of fingerprint logic 320 may compare the sample fingerprint generated by preprocessing feature 322 to a reference fingerprint obtained from model(s) 364 considering the internal processing state of VM 110-1 obtained from state information or indicated in VM event trace data 362. In some examples, comparison feature 324 may generate a deviation value based on the comparison of the sample fingerprint to the reference fingerprint.

Moving to process 4.7A, if the deviation value is less than a threshold deviation value, fingerprint logic 320 may indicate to event read loop logic 310 to read or gather additional data for the generation of a subsequent sample fingerprint as described above for processes 4.1. to 4.5.

Moving to process 4.7B, if the deviation value is greater than a threshold deviation value, fingerprint logic 320 may indicate to code analysis logic 340 that additional analysis is needed.

Moving to process 4.8B, code analysis logic 340 may conduct further analysis on whether the exceeding of the threshold deviation value is normal or not normal.

Moving to process 4.9B1, if code analysis logic 340 determines that the exceeding of the threshold deviation value was due to normal operations of VM 110-1 while executing VNF app(s) 112-1, then the behavior model for VM 110-1 needs updating.

Moving to process 4.10B1, model update logic 350 may update the behavior model for VM 110-1 so that subsequent sample fingerprint comparisons to the updated behavior model don't require further analysis for what was deemed as normal operations.

Moving to process 4.9B2, if code analysis logic 340 determine that the exceeding of the threshold deviation is not normal, then reporting of the not normal operations of VM 110-1 while executing VNF app(s) 112-1 is needed.

Moving to process 4.10B2, report logic 330 may send a report to a management entity to report that sampled or monitored behavior of VM 110-1 while executing VNF app(s) 112-1 indicated behavior that was not normal. In some examples, the report may indicate whether a service performance risk is related to the not normal behavior.

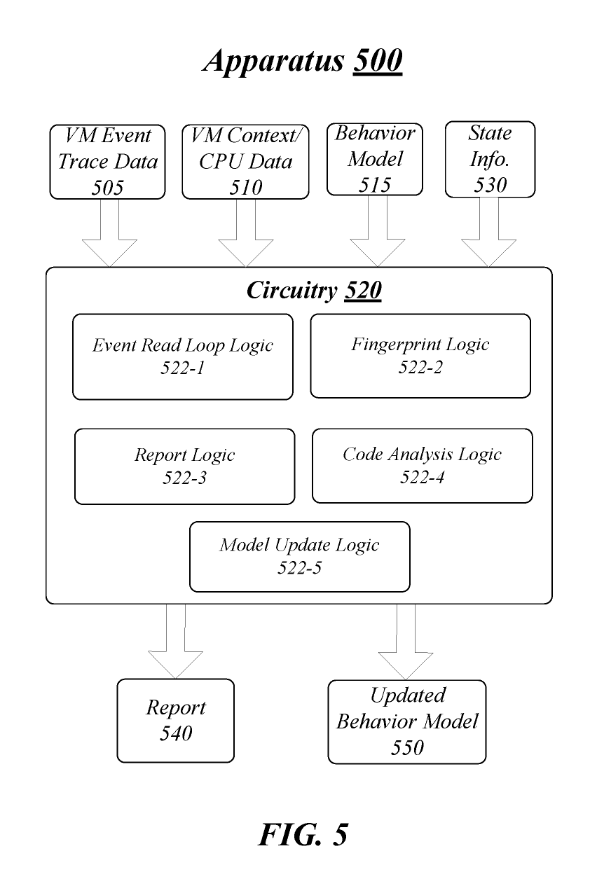

FIG. 5 illustrates an example block diagram for apparatus 500. Although apparatus 500 shown in FIG. 5 has a limited number of elements in a certain topology, it may be appreciated that the apparatus 500 may include more or less elements in alternate topologies as desired for a given implementation.

According to some examples, apparatus 500 may be supported by circuitry 520. For these examples, circuitry 520 may be at a processor, processor circuit, CPU, or core of a CPU for a computing system, e.g., CPU/core 130-N as shown in FIG. 1. For these examples, the processor, processor circuit, CPU, or core of a CPU may support a monitoring daemon such as monitoring daemon 160 shown in FIGS. 1-3. Circuitry 520 may be arranged to execute one or more software or firmware implemented modules, components or logic 522-a (module, component or logic may be used interchangeably in this context). It is worthy to note that “a” and “b” and “c” and similar designators as used herein are intended to be variables representing any positive integer. Thus, for example, if an implementation sets a value for a=5, then a complete set of software or firmware for modules, components or logic 522-a may include logic 522-1, 522-2, 522-3, 522-4 or 522-5. The examples presented are not limited in this context and the different variables used throughout may represent the same or different integer values. Also, “logic”, “module” or “component” may also include software/firmware stored in computer-readable media, and although types of logic are shown in FIG. 5 as discrete boxes, this does not limit these types of logic to storage in distinct computer-readable media components (e.g., a separate memory, etc.).

According to some examples, as mentioned above, circuitry 520 may include a processor, processor circuit, CPU, or core of a CPU. Circuitry 520 may be generally arranged to execute one or more software components 522-a. Circuitry 520 may be all or at least a part of any of various commercially available processors, including without limitation an AMD® Athlon®, Duron® and Opteron® processors; ARM® application, embedded and secure processors; IBM® and Motorola® DragonBall® and PowerPC® processors; IBM and Sony® Cell processors; Intel® Atom®, Celeron®, Core (2) Duo®, Core i3, Core i5, Core i7, Itanium®, Pentium®, Xeon®, Xeon Phi® and XScale® processors; and similar processors. According to some examples circuitry 520 may be configured as an application specific integrated circuit (ASIC) and at least some logic 522-a may be implemented as hardware elements of the ASIC. According to some examples, circuitry 520 may be configured as a field programmable gate array (FPGA) and at least some logic 522-a may be implemented as hardware elements of the FPGA.

According to some examples, apparatus 500 may include an event read loop logic 522-1. Event read loop logic 522-1 may be executed by circuitry 520 to receive information for computing events gathered while a VM executes one or more applications to process a workload for a VNF over a period of time. For these examples, event read loop logic 522-1 may receive the information via VM event trace data 505 and VM context/CPU data 510.

In some examples, apparatus 500 may include a fingerprint logic 522-2. Fingerprint logic 522-2 may be executed by circuitry 520 to generate a sample fingerprint based on the gathered computing events included in the information received by event read loop logic 522-1. As described in examples below, fingerprint logic 522-2 may determine whether to cause a report to be sent to a management entity to indicate a service performance risk for the one or more application to process the workload based on the sample fingerprint.

According to some examples, fingerprint logic 522-2 may compare the sample fingerprint to a reference fingerprint that is included in a behavior model. The behavior model may be included in behavior model 515 (e.g., obtained from a memory coupled with circuitry 520). The reference fingerprint may be based on expected computing events generated while the VM executes the one or more applications to process a target workload for the VNF. For these examples, fingerprint logic 522-1 may determine whether to cause a report to be sent to the management entity to indicate a service performance risk based on the comparison of the sample fingerprint to the reference fingerprint.

In some examples, fingerprint logic 522-2 may generate a deviation value to indicate a difference between the sample fingerprint and the reference fingerprint and then base a decision on whether to cause the report to be sent based on whether the deviation value exceeds a threshold deviation value.

According to some examples, apparatus 500 may also include a report logic 522-3. Report logic 522-4 may be executed by circuitry 520 to send reports to the management entity to indicate a service performance risk. As mentioned above, fingerprint logic 522-2 may cause reports to be sent to the management entity. The reports may be included in reports 540 and may indicate to the management entity that a risk exists for one or more of the VNF applications to malfunction or are exhibiting signs that a malfunction is imminent such that services associated with a VNF are at risk of reaching unacceptable performance levels.

In some examples, apparatus 500 may also include a code analysis logic 522-4. Code analysis logic 522-4 may be executed by circuitry 520 to provide further analysis if fingerprint logic 522-2 determines that a deviation value for a comparison of a sample fingerprint with a reference fingerprint exceeds a threshold deviation value. For these examples, code analysis logic 522-4 may determine whether the deviation value exceeding the threshold deviation value is due to normal operations for the one or more applications to process the workload for the VNF. Normal operations may be based, at least in part, on an internal processing state of the VM executing the one or VNF application. The internal processing state of the VM may be obtained via state information 530. If code analysis logic 522-2 determines that the deviation value exceeding the threshold deviation value is not due to normal operations, then code analysis logic 522-2 may cause report logic 522-3 to send a report to the management entity to indicate a service performance risk.

According to some examples, apparatus 500 may also include a model update logic 522-5. Model update logic 522-5 may be executed by circuitry 520 to update the behavior model used by fingerprint logic 522-2. For these examples, model update logic 522-5 may cause an update to the behavior model if code analysis logic 522-4 determined that the deviation value exceeding the threshold deviation value is due to normal operations. The behavior model may be updated based on the received information for computing events gathered while the VM executes the one or more applications to process the workload for the VNF over the period of time. Model update logic 522-5 may cause the updated behavior model to be stored in a memory coupled with circuitry 520 via updated behavior model 550. In examples where the behavior model is updated at apparatus 500, model update logic 522-5 may perform the computational tasks associated with update the behavior model. In examples were the behavior model is updated remote to apparatus 500, model update logic 522-5 may cause the behavior model to be updated by sending the received information for computing events gathered while the VM executes the one or more applications for use by a remote model update logic and then receive the updated behavior model from the remote model update logic after it is updated.

Various components of apparatus 500 and a device or node implementing apparatus 500 may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Example connections include parallel interfaces, serial interfaces, and bus interfaces.

Included herein is a set of logic flows representative of example methodologies for performing novel aspects of the disclosed architecture. While, for purposes of simplicity of explanation, the one or more methodologies shown herein are shown and described as a series of acts, those skilled in the art will understand and appreciate that the methodologies are not limited by the order of acts. Some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

A logic flow may be implemented in software, firmware, and/or hardware. In software and firmware embodiments, a logic flow may be implemented by computer executable instructions stored on at least one non-transitory computer readable medium or machine readable medium, such as an optical, magnetic or semiconductor storage. The embodiments are not limited in this context.

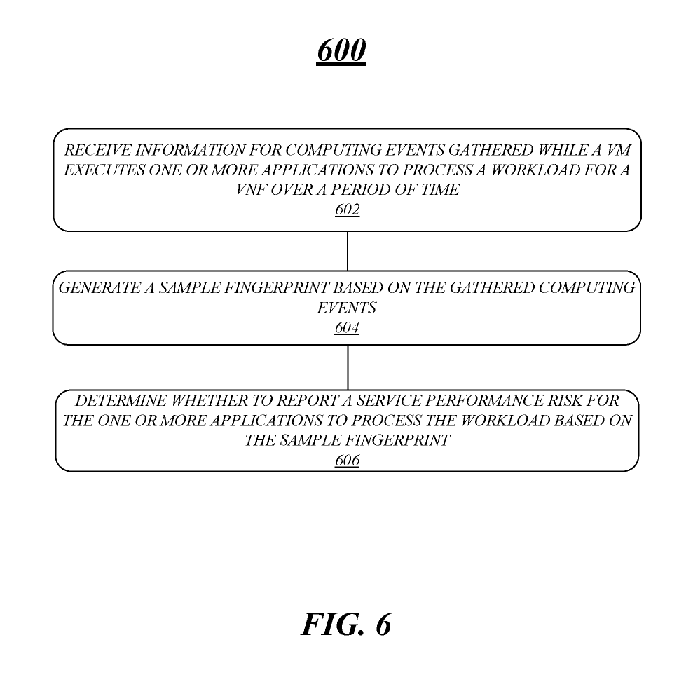

FIG. 6 illustrates an example logic flow 600. Logic flow 600 may be representative of some or all of the operations executed by one or more logic, features, or devices described herein, such as apparatus 600. More particularly, logic flow 600 may be implemented by at least event read loop logic 522-1, fingerprint logic 522-2, report logic 522-3 or code analysis logic 522-4.

According to some examples, logic flow 600 at block 602 may receive information for computing events gathered while a VM executes one or more applications to process a workload for a VNF over a period of time. For these examples, event read loop logic 522-1 may receive the information.

In some examples, logic flow 600 at block 604 may generate a sample fingerprint based on the gathered computing events. For these examples, fingerprint logic 522-2 may generate the sample fingerprint.

According to some examples, logic flow 600 at block 606 may determine whether to report a service performance risk for the one or more applications to process the workload based on the sample fingerprint. For these examples, fingerprint logic 522-2 or code analysis logic 522-4 may cause report logic 522-3 to report a service performance risk based on various types of comparisons or analysis as mentioned previously.

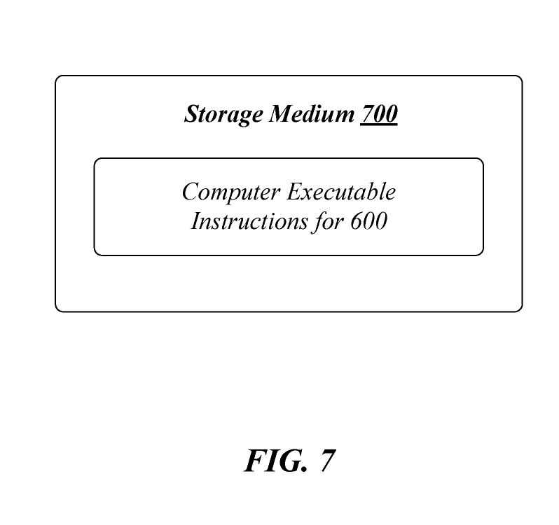

FIG. 7 illustrates an example storage medium 700. As shown in FIG. 7, the first storage medium includes a storage medium 700. The storage medium 700 may comprise an article of manufacture. In some examples, storage medium 700 may include any non-transitory computer readable medium or machine readable medium, such as an optical, magnetic or semiconductor storage. Storage medium 700 may store various types of computer executable instructions, such as instructions to implement logic flow 600. Examples of a computer readable or machine readable storage medium may include any tangible media capable of storing electronic data, including volatile memory or non-volatile memory, removable or non-removable memory, erasable or non-erasable memory, writeable or re-writeable memory, and so forth. Examples of computer executable instructions may include any suitable type of code, such as source code, compiled code, interpreted code, executable code, static code, dynamic code, object-oriented code, visual code, and the like. The examples are not limited in this context.

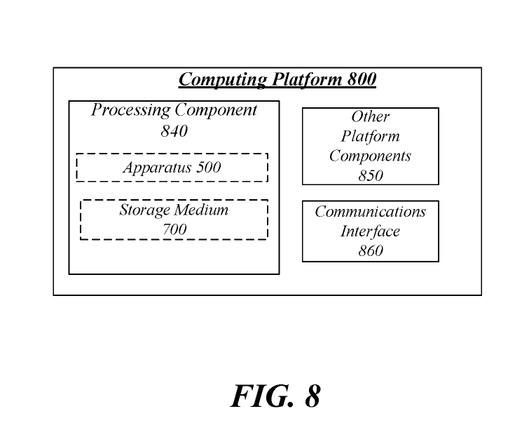

FIG. 8 illustrates an example computing platform 800. In some examples, as shown in FIG. 8, computing platform 800 may include a processing component 840, other platform components 850 or a communications interface 860.

According to some examples, processing component 840 may execute processing operations or logic for apparatus 500 and/or storage medium 700. Processing component 840 may include various hardware elements, software elements, or a combination of both. Examples of hardware elements may include devices, logic devices, components, processors, microprocessors, circuits, processor circuits, circuit elements (e.g., transistors, resistors, capacitors, inductors, and so forth), integrated circuits, ASICs, programmable logic devices (PLDs), digital signal processors (DSPs), FPGAs, memory units, logic gates, registers, semiconductor device, chips, microchips, chip sets, and so forth. Examples of software elements may include software components, programs, applications, computer programs, application programs, device drivers, system programs, software development programs, machine programs, operating system software, middleware, firmware, software modules, routines, subroutines, functions, methods, procedures, software interfaces, application program interfaces (APIs), instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given example.

In some examples, other platform components 850 may include common computing elements, memory units, chipsets, controllers, peripherals, interfaces, oscillators, timing devices, video cards, audio cards, multimedia input/output (I/O) components (e.g., digital displays), power supplies, and so forth. Examples of memory units or memory devices may include without limitation various types of computer readable and machine readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory), solid state drives (SSD) and any other type of storage media suitable for storing information.

In some examples, communications interface 860 may include logic and/or features to support a communication interface. For these examples, communications interface 860 may include one or more communication interfaces that operate according to various communication protocols or standards to communicate over direct or network communication links. Direct communications may occur via use of communication protocols or standards described in one or more industry standards (including progenies and variants) such as those associated with the PCIe specification. Network communications may occur via use of communication protocols or standards such those described in one or more Ethernet standards promulgated by the Institute of Electrical and Electronics Engineers (IEEE). For example, one such Ethernet standard promulgated by IEEE may include, but is not limited to, IEEE 802.3-2012, Carrier sense Multiple access with Collision Detection (CSMA/CD) Access Method and Physical Layer Specifications, Published in December 2012 (hereinafter “IEEE 802.3 specification”). Network communication may also occur according to one or more OpenFlow specifications such as the OpenFlow Hardware Abstraction API Specification. Network communications may also occur according to Infiniband Architecture specification.

Computing platform 800 may be implemented in a server or client computing device. Accordingly, functions and/or specific configurations of computing platform 800 described herein, may be included or omitted in various embodiments of computing platform 800, as suitably desired for a server or client computing device.

The components and features of computing platform 800 may be implemented using any combination of discrete circuitry, application specific integrated circuits (ASICs), logic gates and/or single chip architectures. Further, the features of computing platform 800 may be implemented using microcontrollers, programmable logic arrays and/or microprocessors or any combination of the foregoing where suitably appropriate. It is noted that hardware, firmware and/or software elements may be collectively or individually referred to herein as “logic” or “circuit.”

It should be appreciated that the exemplary computing platform 800 shown in the block diagram of FIG. 8 may represent one functionally descriptive example of many potential implementations. Accordingly, division, omission or inclusion of block functions depicted in the accompanying figures does not infer that the hardware components, circuits, software and/or elements for implementing these functions would necessarily be divided, omitted, or included in embodiments.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that actually make the logic or processor.

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

Some examples may include an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner or syntax, for instructing a machine, computing device or system to perform a certain function. The instructions may be implemented using any suitable high-level, low-level, object-oriented, visual, compiled and/or interpreted programming language.

Some examples may be described using the expression “in one example” or “an example” along with their derivatives. These terms mean that a particular feature, structure, or characteristic described in connection with the example is included in at least one example. The appearances of the phrase “in one example” in various places in the specification are not necessarily all referring to the same example.

Some examples may be described using the expression “coupled” and “connected” along with their derivatives. These terms are not necessarily intended as synonyms for each other. For example, descriptions using the terms “connected” and/or “coupled” may indicate that two or more elements are in direct physical or electrical contact with each other. The term “coupled” or “coupled with”, however, may also mean that two or more elements are not in direct contact with each other, but yet still co-operate or interact with each other.

The follow examples pertain to additional examples of technologies disclosed herein.

### Example 1

An example apparatus includes a memory and a processor circuit coupled with the memory. For these examples, the processing circuit may execute logic. The logic may receive information for computing events gathered while a VM executes one or more applications to process a workload for a VNF over a period of time. The logic may also generate a sample fingerprint based on the gathered computing events. The logic may also determine whether to report a service performance risk for the one or more applications to process the workload based on the sample fingerprint.

### Example 2

The apparatus of example 1, the logic may also compare the sample fingerprint to a reference fingerprint that is included in a behavior model stored in the memory. The reference fingerprint may be based on expected computing events generated while the VM executes the one or more applications to process a target workload for the VNF. The logic may also determine whether to report a service performance risk based on the comparison of the sample fingerprint to the reference fingerprint.

### Example 3

The apparatus of example 2, the logic may also generate a deviation value to indicate a difference between the sample fingerprint and the reference fingerprint. The logic may also determine whether to report a service performance risk based on whether the deviation value exceeds a threshold deviation value.

### Example 4

The apparatus of example 3, the logic may also determine that the deviation value exceeds the threshold deviation value and determine whether the deviation value exceeding the threshold deviation value is due to normal operations for the one or more applications to process the workload for the VNF.

### Example 5

The apparatus of example 4, the logic may also report the service performance risk if the deviation value exceeding the threshold deviation value is not due to normal operations.

### Example 6

The apparatus of example 4, the logic to may also cause an update to the behavior model based on a determination that the deviation value exceeding the threshold deviation value is due to normal operations. The behavior model may be updated based on the received information for computing events gathered while the VM executes the one or more applications to process the workload for the VNF over the period of time. The logic may also cause the updated behavior model to be stored to the memory.

### Example 7

The apparatus of example 1, the logic may also determine not to report a service performance risk based on the memory not including a behavior model that includes a reference fingerprint. The logic may also create a behavior model that includes the sample fingerprint as the reference fingerprint and cause the created behavior model to be stored to the memory.

### Example 8

The apparatus of example 1, the information for computing events gathered while the VM executes the one or more applications may include computing events that occur at CPUs or cores allocated to support the VM, the computing events to include instructions retired, branch miss predicts, cache misses or translation lookaside buffer misses.

### Example 9

The apparatus of example 8, the computing events gathered by the CPUs or cores allocated to support the VM via use of one or more of a PEBS, a PT, EMT or a BTS.

### Example 10

The apparatus of example 1, the VNF may provide a service, the service to include a firewalling service, a DNS, a caching service or NAT service.

### Example 11

The apparatus of example 1, the memory may include one or more of a volatile memory or a non-volatile memory.

### Example 12

The apparatus of example 11, the volatile memory may include RAM, DRAM, DDR SDRAM, SRAM, TRAM or ZRAM. The non-volatile memory may include phase change memory that uses chalcogenide phase change material, flash memory, ferroelectric memory, SONOS memory, polymer memory, ferroelectric polymer memory, FeTRAM, FeRAM, ovonic memory, nanowire, electrically EEPROM, phase change memory, memristors or STT-MRAM.

### Example 13

An example method may include receiving, at a processor circuit, information for computing events gathered while a VM executes one or more applications to process a workload for a VNF over a period of time. The method may also include generating a sample fingerprint based on the gathered computing events. The method may also include determining whether to report a service performance risk for the one or more applications to process the workload based on the sample fingerprint.

### Example 14

The method of example 13 may also include comparing the sample fingerprint to a reference fingerprint that is included in a behavior model. The reference fingerprint may be based on expected computing events generated while the VM executes the one or more applications to process a target workload for the VNF. The method may also include determining whether to report a service performance risk based on the comparison of the sample fingerprint to the reference fingerprint.

### Example 15

The method of example 14 may also include generating a deviation value to indicate a difference between the sample fingerprint and the reference fingerprint. The method may also include determining whether to report a service performance risk based on whether the deviation value exceeds a threshold deviation value.

### Example 16

The method of example 15 may also include determining that the deviation value exceeds the threshold deviation value and determining whether the deviation value exceeding the threshold deviation value is due to normal operations for the one or more applications to process the workload for the VNF.

### Example 17

The method of example 16 may also include reporting the service performance risk if the deviation value exceeding the threshold deviation value is not due to normal operations.

### Example 18

The method of example 16 may also include updating the behavior model based on a determination that the deviation value exceeding the threshold deviation value is due to normal operations, the behavior model updated based on the received information for computing events gathered while the VM executes the one or more applications to process the workload for the VNF over the period of time.

### Example 19

The method of example 13 may also include determining not to report a service performance risk based on not having a behavior model that includes a reference fingerprint. The method may also include creating a behavior model that includes the sample fingerprint as the reference fingerprint and storing the created behavior model.

### Example 20

The method of example 13, the information for computing events gathered while the VM executes the one or more applications may include computing events occurring at CPUs or cores allocated to support the VM, the computing events including instructions retired, branch miss predicts, cache misses or translation lookaside buffer misses.

### Example 21

The method of example 20 may also include the computing events gathered by the CPUs or cores allocated to support the VM using one or more of a PEBS, a PT, EMT or a BTS.

### Example 22

The method of example 13, the VNF may provide a firewalling service, a DNS, a caching service or NAT service.

### Example 23

An example at least one machine readable medium may include a plurality of instructions that in response to being executed by a system may cause the system to carry out a method according to any one of examples 13 to 22.

### Example 24

An example apparatus may include means for performing the methods of any one of examples 13 to 22.

### Example 25

An example at least one machine readable medium may include a plurality of instructions that in response to being executed by a system may cause the system to receive information for computing events gathered while a VM executes one or more applications to process a workload for a VNF over a period of time. The instructions may also cause the system to generate a sample fingerprint based on the gathered computing events. The instructions may also cause the system to determine whether to report a service performance risk for the one or more applications to process the workload based on the sample fingerprint.

### Example 26

The at least one machine readable medium of example 25, the instructions may also cause the system to compare the sample fingerprint to a reference fingerprint that is included in a behavior model. The reference fingerprint may be based on expected computing events generated while the VM executes the one or more applications to process a target workload for the VNF. The instructions may also cause the system to determine whether to report a service performance risk based on the comparison of the sample fingerprint to the reference fingerprint.

### Example 27

The at least one machine readable medium of example 26, the instructions may also cause the system to generate a deviation value to indicate a difference between the sample fingerprint and the reference fingerprint. The instructions may also cause the system to determine whether to report a service performance risk based on whether the deviation value exceeds a threshold deviation value.

### Example 28

The at least one machine readable medium of example 27, the instructions may also cause the system to determine that the deviation value exceeds the threshold deviation value determine whether the deviation value exceeding the threshold deviation value is due to normal operations for the one or more applications to process the workload for the VNF.

### Example 29

The at least one machine readable medium of example 28, the instructions may also cause the system to report the service performance risk if the deviation value exceeding the threshold deviation value is not due to normal operations.

### Example 30

The at least one machine readable medium of example 28, the instructions may also cause the system to cause an update to the behavior model based on a determination that the deviation value exceeding the threshold deviation value is due to normal operations. The behavior model may be updated based on the received information for computing events gathered while the VM executes the one or more applications to process the workload for the VNF over the period of time. The instructions may also cause the system to cause the updated behavior model to be stored to a memory.

### Example 31

The at least one machine readable medium of example 25, the instructions may also cause the system to determine not to report a service performance risk based on not having a behavior model that includes a reference fingerprint. The instructions may also cause the system to create a behavior model that includes the sample fingerprint as the reference fingerprint and cause the created behavior model to be stored to a memory.

### Example 32

The at least one machine readable medium of example 25, the information for computing events gathered while the VM executes the one or more applications may include computing events that occur at CPUs or cores allocated to support the VM, the computing events to include instructions retired, branch miss predicts, cache misses or translation lookaside buffer misses.

### Example 33

The at least one machine readable medium of example 32, the computing events may be gathered by the CPUs or cores allocated to support the VM via use of one or more of a PEBS, PT, EMT or BTS

### Example 34

The at least one machine readable medium of example 25, the VNF may provide a service, the service to include a firewalling service, a DNS, a caching service or NAT service.

It is emphasized that the Abstract of the Disclosure is provided to comply with 37 C.F.R. Section 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single example for the purpose of streamlining the disclosure. This method of disclosure is not to be interpreted as reflecting an intention that the claimed examples require more features than are expressly recited in each claim. Rather, as the following claims reflect, inventive subject matter lies in less than all features of a single disclosed example. Thus the following claims are hereby incorporated into the Detailed Description, with each claim standing on its own as a separate example. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. An apparatus comprising:
a memory; and
a processor circuit coupled with the memory to execute logic, the logic to:
receive information for computing events gathered while a virtual machine (VM) executes one or more applications to process a workload for a virtual network function (VNF) over a period of time;
generate a sample fingerprint based on the gathered computing events; and
determine whether to report a service performance risk for the one or more applications to process the workload based on the sample fingerprint.

2. The apparatus of claim 1, comprising the logic to:
compare the sample fingerprint to a reference fingerprint that is included in a behavior model stored in the memory, the reference fingerprint based on expected computing events generated while the VM executes the one or more applications to process a target workload for the VNF; and
determine whether to report a service performance risk based on the comparison of the sample fingerprint to the reference fingerprint.

3. The apparatus of claim 2, comprising the logic to:
generate a deviation value to indicate a difference between the sample fingerprint and the reference fingerprint; and
determine whether to report a service performance risk based on whether the deviation value exceeds a threshold deviation value.

4. The apparatus of claim 3, comprising the logic to:
determine that the deviation value exceeds the threshold deviation value; and
determine whether the deviation value exceeding the threshold deviation value is due to normal operations for the one or more applications to process the workload for the VNF.

5. The apparatus of claim 4, comprising the logic to:
report the service performance risk if the deviation value exceeding the threshold deviation value is not due to normal operations.

6. The apparatus of claim 4, comprising the logic to:
cause an update to the behavior model based on a determination that the deviation value exceeding the threshold deviation value is due to normal operations, the behavior model updated based on the received information for computing events gathered while the VM executes the one or more applications to process the workload for the VNF over the period of time; and
cause the updated behavior model to be stored to the memory.

7. The apparatus of claim 1, comprising the logic to:
determine not to report a service performance risk based on the memory not including a behavior model that includes a reference fingerprint;
create a behavior model that includes the sample fingerprint as the reference fingerprint; and
cause the created behavior model to be stored to the memory.

8. The apparatus of claim 1, the information for computing events gathered while the VM executes the one or more applications comprises computing events that occur at central processing units (CPUs) or cores allocated to support the VM, the computing events to include instructions retired, branch miss predicts, cache misses or translation lookaside buffer misses.

9. The apparatus of claim 8, comprising the computing events gathered by the CPUs or cores allocated to support the VM via use of one or more of a precise event based sampling (PEBS), a processor trace (PT), embedded trace microcell (EMT) or a branch target store (BTS).

10. The apparatus of claim 1, the VNF comprises the VNF to provide a service, the service to include a firewalling service, a domain name service (DNS), a caching service or network address translation (NAT) service.

11. The apparatus of claim 1, the memory comprising one or more of a volatile memory or a non-volatile memory.

12. A method comprising:
receiving, at a processor circuit, information for computing events gathered while a virtual machine (VM) executes one or more applications to process a workload for a virtual network function (VNF) over a period of time;
generating a sample fingerprint based on the gathered computing events; and
determining whether to report a service performance risk for the one or more applications to process the workload based on the sample fingerprint.

13. The method of claim 12, comprising:
comparing the sample fingerprint to a reference fingerprint that is included in a behavior model, the reference fingerprint based on expected computing events generated while the VM executes the one or more applications to process a target workload for the VNF; and
determining whether to report a service performance risk based on the comparison of the sample fingerprint to the reference fingerprint.

14. The method of claim 13, comprising:
generating a deviation value to indicate a difference between the sample fingerprint and the reference fingerprint; and
determining whether to report a service performance risk based on whether the deviation value exceeds a threshold deviation value.

15. The method of claim 14, comprising:
determining that the deviation value exceeds the threshold deviation value;
determining whether the deviation value exceeding the threshold deviation value is due to normal operations for the one or more applications to process the workload for the VNF; and
reporting the service performance risk if the deviation value exceeding the threshold deviation value is not due to normal operations.

16. The method of claim 15, comprising:
updating the behavior model based on a determination that the deviation value exceeding the threshold deviation value is due to normal operations, the behavior model updated based on the received information for computing events gathered while the VM executes the one or more applications to process the workload for the VNF over the period of time.

17. The method of claim 12, comprising:
determining not to report a service performance risk based on not having a behavior model that includes a reference fingerprint;
creating a behavior model that includes the sample fingerprint as the reference fingerprint; and
storing the created behavior model.

18. The method of claim 12, the information for computing events gathered while the VM executes the one or more applications comprises computing events occurring at central processing units (CPUs) or cores allocated to support the VM, the computing events including instructions retired, branch miss predicts, cache misses or translation lookaside buffer misses.

19. At least one machine readable medium comprising a plurality of instructions that in response to being executed by a system cause the system to:
receive information for computing events gathered while a virtual machine (VM) executes one or more applications to process a workload for a virtual network function (VNF) over a period of time;
generate a sample fingerprint based on the gathered computing events; and
determine whether to report a service performance risk for the one or more applications to process the workload based on the sample fingerprint.

20. The at least one machine readable medium of claim 19, comprising the instructions to cause the system to:
compare the sample fingerprint to a reference fingerprint that is included in a behavior model, the reference fingerprint based on expected computing events generated while the VM executes the one or more applications to process a target workload for the VNF; and
determine whether to report a service performance risk based on the comparison of the sample fingerprint to the reference fingerprint.

21. The at least one machine readable medium of claim 20, comprising the instructions to cause the system to:
generate a deviation value to indicate a difference between the sample fingerprint and the reference fingerprint; and
determine whether to report a service performance risk based on whether the deviation value exceeds a threshold deviation value.

22. The at least one machine readable medium of claim 21, comprising the instructions to cause the system to:
determine that the deviation value exceeds the threshold deviation value;
determine whether the deviation value exceeding the threshold deviation value is due to normal operations for the one or more applications to process the workload for the VNF; and
report the service performance risk if the deviation value exceeding the threshold deviation value is not due to normal operations.

23. The at least one machine readable medium of claim 22, comprising the instructions to cause the system to:
cause an update to the behavior model based on a determination that the deviation value exceeding the threshold deviation value is due to normal operations, the behavior model updated based on the received information for computing events gathered while the VM executes the one or more applications to process the workload for the VNF over the period of time; and
cause the updated behavior model to be stored to a memory.

24. The at least one machine readable medium of claim 19, comprising the instructions to cause the system to:
determine not to report a service performance risk based on not having a behavior model that includes a reference fingerprint;
create a behavior model that includes the sample fingerprint as the reference fingerprint; and
cause the created behavior model to be stored to a memory.

25. The at least one machine readable medium of claim 19, the information for computing events gathered while the VM executes the one or more applications comprises computing events that occur at central processing units (CPUs) or cores allocated to support the VM, the computing events to include instructions retired, branch miss predicts, cache misses or translation lookaside buffer misses.
